(19) United States
(12) Patent Application Publication
(10) Pub. No.: US 2019/0192255 A1
(43) Pub. Date: Jun. 27, 2019

(54) Dental Instrument Silencer Assembly

(71) Applicant: Sarah Rzeszotko, Burlington (CA)

(72) Inventor: Sarah Rzeszotko, Burlington (CA)

(21) Appl. No.: 15/855,249

(22) Filed: Dec. 27, 2017

(51) Int. Cl. A61C 1/08; A61C 17/20

(52) U.S. Cl. CPC A61C 1/08; A61C 17/20

(57) ABSTRACT

A dental instrument silencer assembly for reducing noise from a dental instrument includes a silencer that may have a dental instrument extended therethrough. The silencer is gripped for manipulating the dental instrument. Moreover, the silencer is comprised of an acoustically insulating material to reduce noise produced by the dental instrument when the dental instrument is turned on. A first cap is removably coupled to the silencer to frictionally engage the dental instrument. The first cap is comprised of a resiliently compressible material to absorb vibration from the dental instrument when the dental instrument is turned on. A second cap is removably coupled to the silencer to retain the dental instrument in the silencer.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to silencer devices and more particularly pertains to a new silencer device for reducing noise from a dental instrument.

### BRIEF SUMMARY OF THE INVENTION

An embodiment of the disclosure meets the needs presented above by generally comprising a silencer that may have a dental instrument extended therethrough. The silencer is gripped for manipulating the dental instrument. Moreover, the silencer is comprised of an acoustically insulating material to reduce noise produced by the dental instrument when the dental instrument is turned on. A first cap is removably coupled to the silencer to frictionally engage the dental instrument. The first cap is comprised of a resiliently compressible material to absorb vibration from the dental instrument when the dental instrument is turned on. A second cap is removably coupled to the silencer to retain the dental instrument in the silencer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a dental instrument silencer assembly according to an embodiment of the disclosure.

FIG. 2 is a front view of an embodiment of the disclosure.

FIG. 3 is a right side view of an embodiment of the disclosure.

FIG. 4 is a back view of an embodiment of the disclosure.

FIG. 5 is an exploded perspective view of an embodiment of the disclosure.

FIG. 6 is a cross sectional view taken along line 6-6 of FIG. 5 of an embodiment of the disclosure.

FIG. 7 is a perspective in-use view of an embodiment of the disclosure.

FIG. 8 is a cross sectional view taken along line 8-8 of FIG. 3 of an embodiment of the disclosure.

### DETAILED DESCRIPTION OF THE INVENTION

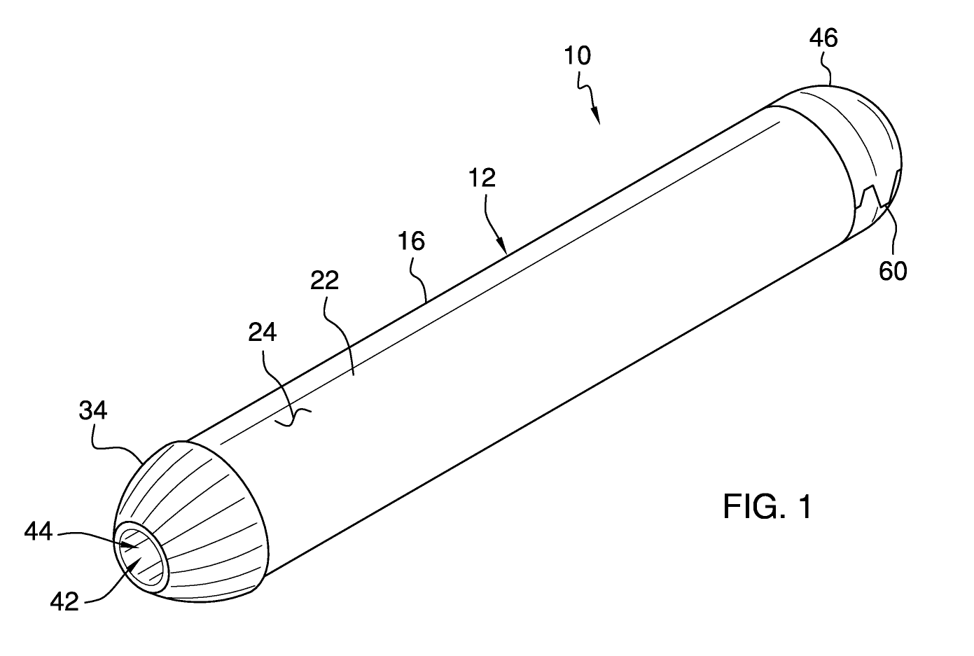

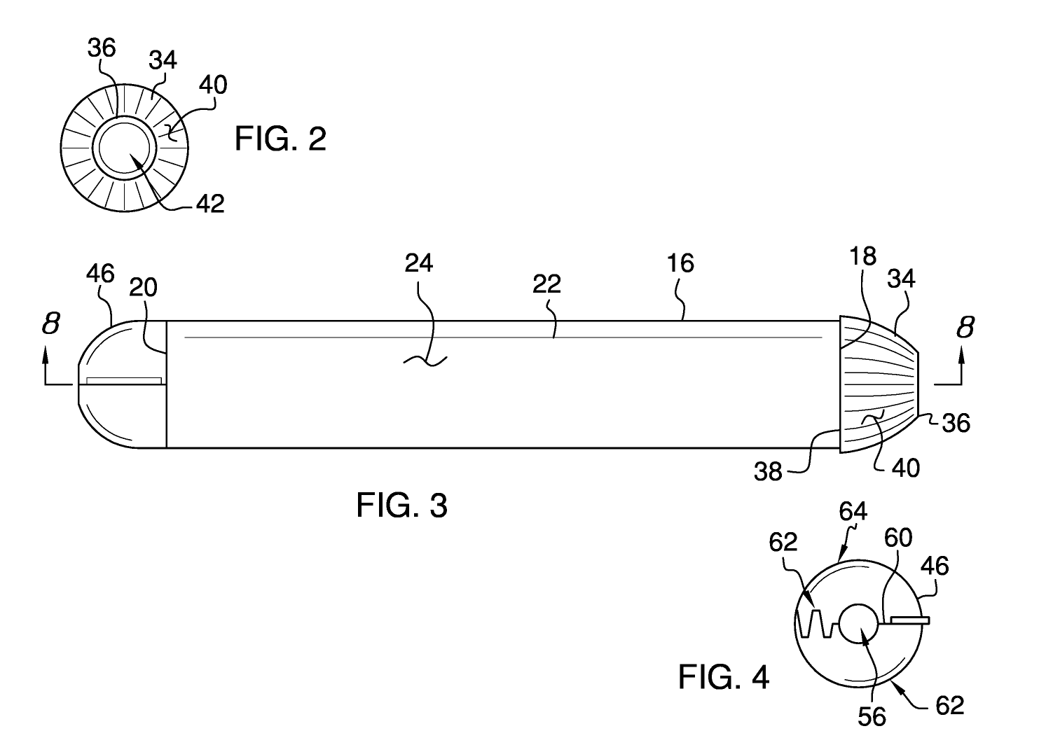

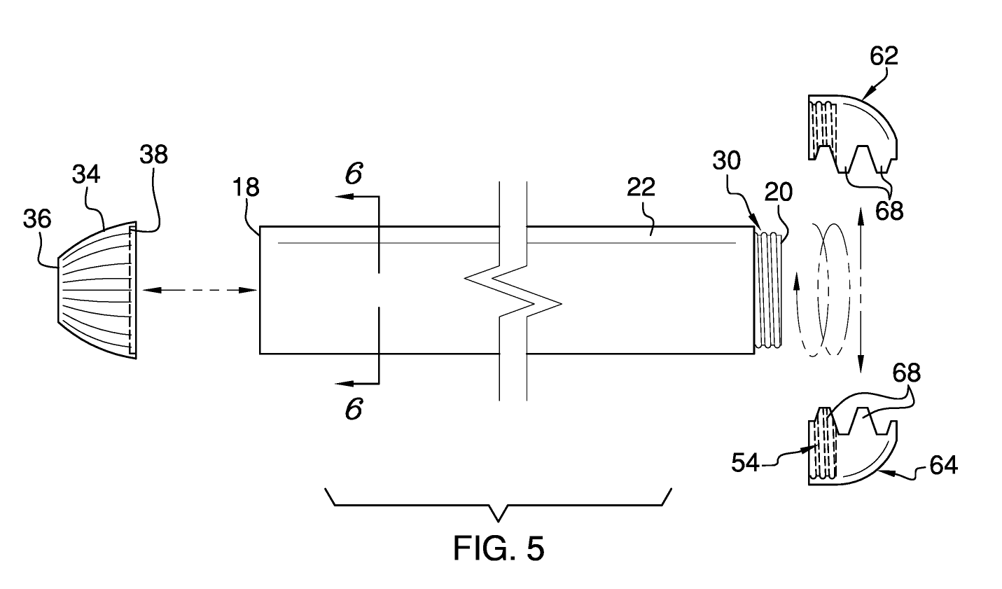

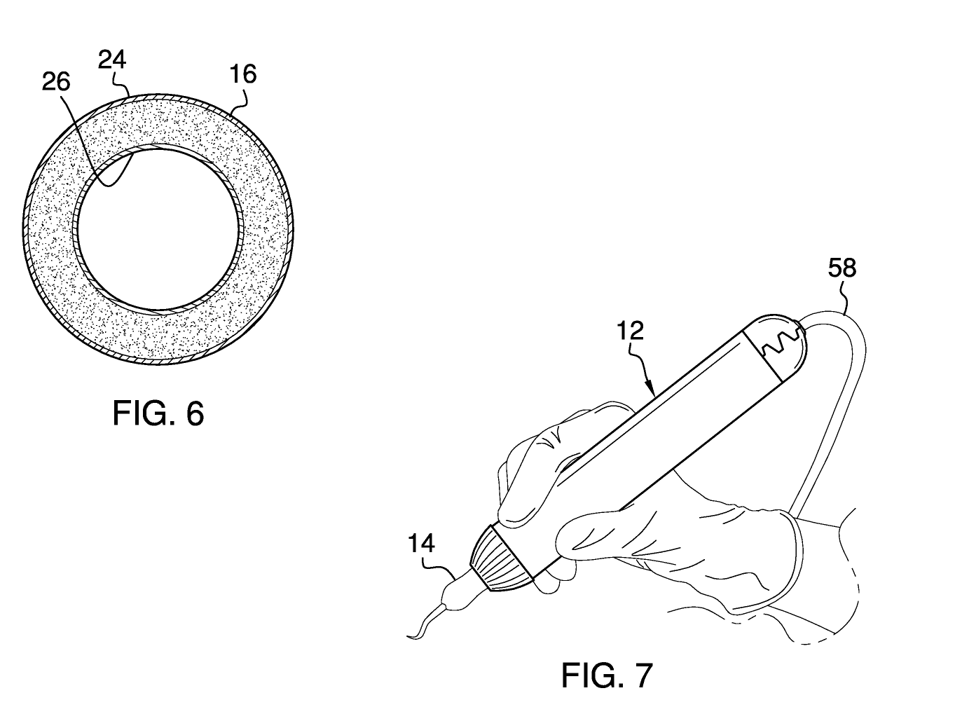

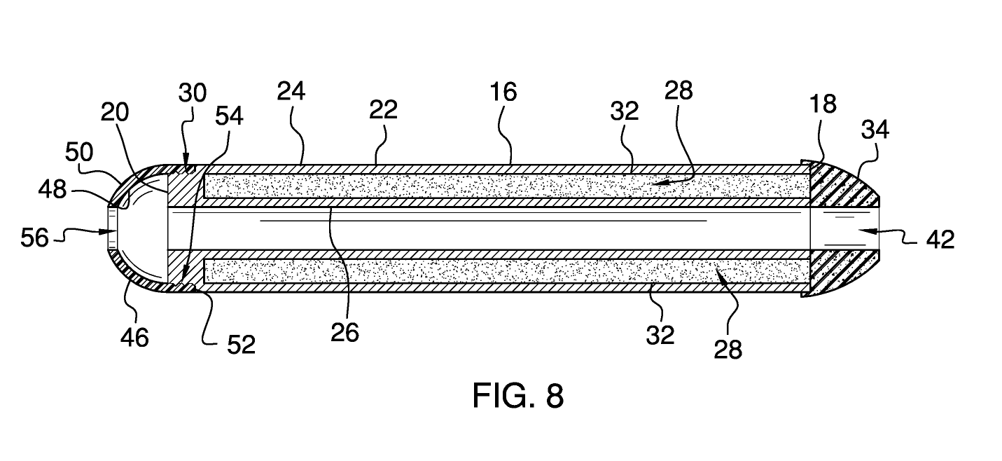

With reference now to the drawings, and in particular to FIGS. 1 through 8 thereof, a new silencer device embodying the principles and concepts of an embodiment of the disclosure and generally designated by the reference numeral 10 will be described.

As best illustrated in FIGS. 1 through 8, the dental instrument silencer assembly 10 generally comprises a silencer 12 that insertably receives a dental instrument 14. The dental instrument 14 may be an ultrasonic scaler or other electronic dental instrument that produces high frequency vibrations. The silencer 12 is gripped for manipulating the dental instrument 14. Additionally, the silencer 12 is comprised of an acoustically insulating material to reduce noise produced by the dental instrument 14 when the dental instrument 14 is turned on. In this way the silencer 12 enhances comfort for a dental patient when the dental instrument 14 is being employed.

The silencer 12 comprises a tube 16 and the dental instrument 14 is extended through the tube 16. The tube 16 is comprised of a rigid material such as plastic or the like and the tube 16 has a first end 18, a second end 20 and an outer wall 22 extending therebetween. The outer wall 22 has an outside surface 24 and an inside surface 26 and the inside surface 26 frictionally engages the dental instrument 14. In this way the outer wall 22 of the tube 16 is in mechanical communication with the dental instrument 14 thereby facilitating vibration from the dental instrument 14 to be transferred into the tube 16 when the dental instrument 14 is turned on.

The outer wall 22 has a chamber 28 therein and the chamber 28 is positioned between the outside surface 24 and the inside surface 26. The chamber 28 extends substantially between the first end 18 and the second end 20. Additionally, the outside surface 24 has a threaded portion 30 extending from the first end 20 toward the second end 18. The tube 16 may have a length ranging between approximately 15.0 cm and 30.0 cm and an outside diameter ranging between approximately 2.0 cm and 4.0 cm. Moreover, the outside diameter of the tube 16 is large enough to reduce symptoms of carpal tunnel syndrome.

A muffle 32 is positioned within the chamber 28 and the muffle 32 completely fills the chamber 28. The muffle 32 is comprised of an acoustically insulating material such as foam rubber, green glue and any other deformable material that can absorb vibrational energy. Thus, the muffle 32 absorbs vibration from the dental instrument 14 when the dental instrument 14 is turned on thereby reducing audible noise produced by the vibration.

A first cap 34 is removably coupled to the silencer 12 and the first cap 34 frictionally engages the dental instrument 14. The first cap 34 is comprised of a resiliently compressible material such as rubber or the like. Thus, the first cap 34 absorbs vibration from the dental instrument 14 when the dental instrument 14 is turned on. The first cap 34 has a front end 36, a back end 38 and an outer surface 40 extending therebetween and the outer surface 40 tapers inwardly between the back end 38 and the front end 36. The first cap 34 has an aperture 42 extending through the front end 36 and the back end 38 and the aperture 42 has a bounding surface 44. The back end 38 releasably engages the first end 18 of the tube 16 and the dental instrument 14 is extended through the aperture 42. Additionally, the bounding surface 44 of the aperture 42 frictionally engages the dental instrument 14.

A second cap 46 is removably coupled to the silencer 12 and the second cap 46 retains the dental instrument 14 in the silencer 12. The second cap 46 has an inside surface 48, an outside surface 50 and an outer edge 52 extending therebetween. Each of the inside surface 26 and the outside surface 24 is concavely arcuate such that the second cap 46 forms a bowl. The inside surface 26 has a threaded portion 54 extending downwardly from the outer edge 52. Additionally, the threaded portion 54 of the second cap 46 threadably engages the threaded portion 30 of the tube 16. In this way the second cap 46 is removably retained on the tube 16 to retain the dental instrument 14 in the tube 16.

The second cap 46 has an opening 56 extending through the inside surface 26 and the outside surface 24 and a cord 58 on the dental instrument 14 is extended through the opening 56. The second cap 46 has a cut 60 extending through the inside surface 26 and the outside surface 24 to define a first half 62 of the second cap 46 and the second half 64 of the second cap 46. The cut 60 has a crenellated portion 66 to define a plurality of teeth 68 on each of the first half 62 and the second half 64. Moreover, the plurality of teeth 68 on the second half 64 is enmeshed with the plurality of teeth 68 on the first half 62.

In use, the dental instrument 14 is extended through the tube 16 prior to being used. The first cap 34 is slid over the dental instrument 14 and the first cap 34 is positioned on the first end 18 of the tube 16. Additionally, an activation end of the dental instrument 14 is exposed for use in dental procedures. Each of the first half 62 and the second half 64 of the second cap 46 are positioned around the cord 58 and the second cap 46 is threadably coupled to the second end 20 of the tube 16. The muffle 32 absorbs vibration from the dental instrument 14 thereby reducing audible noise for the dental patient. The outer wall 22 of the tube 16 is gripped to manipulate the dental instrument 14 during the dental procedure.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dental instrument silencer assembly being configured to be positioned around a dental instrument thereby reducing noise produced by the dental instrument, said assembly comprising:
a silencer being configured to have a dental instrument extended therethrough, said silencer being configured to be gripped for manipulating the dental instrument, said silencer being comprised of an acoustically insulating material wherein said silencer is configured to reduce noise produced by the dental instrument when the dental instrument is turned on;
a first cap being removably coupled to said silencer wherein said first cap is configured to frictionally engage the dental instrument, said first cap being comprised of a resiliently compressible material wherein said first cap is configured to absorb vibration from the dental instrument when the dental instrument is turned on; and
a second cap being removably coupled to said silencer wherein said second cap is configured to retain the dental instrument in said silencer.

2. The assembly according to claim 1 wherein said silencer comprises a tube being configured to have the dental instrument extended therethrough, said tube being comprised of a rigid material, said tube having a first end, a second end and an outer wall extending therebetween, said outer wall having an outside surface and an inside surface, said inside surface being configured to frictionally engage the dental instrument such that said outer wall of said tube is in mechanical communication with the dental instrument thereby facilitating vibration from the dental instrument to be transferred into said tube when the dental instrument is turned on.

3. The assembly according to claim 2, wherein said outer wall having a chamber therein, said chamber being positioned between said outside surface and said inside surface, said chamber extending substantially between said first end and said second end, said outside surface having a threaded portion extending from said second end toward said first end.

4. The assembly according to claim 3, further comprising a muffle being positioned within said chamber such that said muffle completely fills said chamber, said muffle being comprised of an acoustically insulating material wherein said muffle is configured to absorb vibration from the dental instrument when the dental instrument is turned on thereby reducing audible noise produced by the vibration.

5. The assembly according to claim 2, wherein said first cap has a front end, a back end and an outer surface extending therebetween, said outer surface tapering inwardly between said back end and said front end.

6. The assembly according to claim 5, wherein said first cap has an aperture extending through said front end and said back end, said aperture having a bounding surface, said back end releasably engaging said first end of said tube wherein said instrument aperture is configured to have the dental instrument extended therethrough, said bounding surface being configured to frictionally engage the dental instrument.

7. The assembly according to claim 3, wherein said second cap has an inside surface, and outside surface and an outer edge extending therebetween, each of said inside surface and said outside surface being concavely arcuate such that said second cap forms a bowl, said inside surface having a threaded portion extending downwardly from said outer edge, said threaded portion of said second cap threadably engaging said threaded portion of said tube such that said second cap is removably retained on said tube wherein said second cap is configured to retain the dental instrument in said tube.

8. The assembly according to claim 7, wherein said second cap has an opening extending through said inside surface and said outside surface wherein said opening is configured to have a cord on the dental instrument extended therethrough.

9. The assembly according to claim 8, wherein said second cap has a cut extending through said inside surface and said outside surface to define a first half of said second cap and the second half of said second cap.

10. The assembly according to claim 9, further comprising said cut has a crenellated portion to define a plurality of teeth on each of said first half and said second half, said plurality of teeth on said second half being enmeshed with said teeth on said first half.

11. A dental instrument silencer assembly being configured to be positioned around a dental instrument thereby reducing noise produced by the dental instrument, said assembly comprising:
a silencer being configured to have a dental instrument extended therethrough, said silencer being configured to be gripped for manipulating the dental instrument, said silencer being comprised of an acoustically insulating material wherein said silencer is configured to reduce noise produced by the dental instrument when the dental instrument is turned on, said silencer comprising:
a tube being configured to have the dental instrument extended therethrough, said tube being comprised of a rigid material, said tube having a first end, a second end and an outer wall extending therebetween, said outer wall having an outside surface and an inside surface, said inside surface being configured to frictionally engage the dental instrument such that said outer wall of said tube is in mechanical communication with the dental instrument thereby facilitating vibration from the dental instrument to be transferred into said tube when the dental instrument is turned on, said outer wall having a chamber therein, said chamber being positioned between said outside surface and said inside surface, said chamber extending substantially between said first end and said second end, said outside surface having a threaded portion extending from said second end toward said first end; and
a muffle being positioned within said chamber such that said muffle completely fills said chamber, said muffle being comprised of an acoustically insulating material wherein said muffle is configured to absorb vibration from the dental instrument when the dental instrument is turned on thereby reducing audible noise produced by the vibration; and
a first cap being removably coupled to said silencer wherein said first cap is configured to frictionally engage the dental instrument, said first cap being comprised of a resiliently compressible material wherein said first cap is configured to absorb vibration from the dental instrument when the dental instrument is turned on, said first cap having a front end, a back end and an outer surface extending therebetween, said outer surface tapering inwardly between said back end and said front end, said first cap having an aperture extending through said front end and said back end, said aperture having a bounding surface, said back end releasably engaging said first end of said tube wherein said instrument aperture is configured to have the dental instrument extended therethrough, said bounding surface being configured to frictionally engage the dental instrument; and
a second cap being removably coupled to said silencer wherein said second cap is configured to retain the dental instrument in said silencer, said second cap having an inside surface, and outside surface and an outer edge extending therebetween, each of said inside surface and said outside surface being concavely arcuate such that said second cap forms a bowl, said inside surface having a threaded portion extending downwardly from said outer edge, said threaded portion of said second cap threadably engaging said threaded portion of said tube such that said second cap is removably retained on said tube wherein said second cap is configured to retain the dental instrument in said tube, said second cap having an opening extending through said inside surface and said outside surface wherein said opening is configured to have a cord on the dental instrument extended therethrough, said second cap having a cut extending through said inside surface and said outside surface to define a first half of said second cap and the second half of said second cap, said cut having a crenellated portion to define a plurality of teeth on each of said first half and said second half, said plurality of teeth on said second half being enmeshed with said teeth on said first half.
